(19) United States
(12) Patent Application Publication
(10) Pub. No.: US 2015/0161604 A1
(43) Pub. Date: Jun. 11, 2015

(54) DETERMINING A TRANSACTION TARGET IDENTIFIER

(71) Applicant: Alibaba Group Holding Limited, George Town (KY)

(72) Inventors: Yihua He, Hangzhou (CN); Hong Deng, Beijing (CN); Huimei He, Hangzhou (CN); Hao Zhang, Beijing (CN); Lei Pang, Beijing (CN); Gang Li, Beijing (CN); Xingliang Liu, Hangzhou (CN); Dijun He, Hangzhou (CN)

(21) Appl. No.: 14/553,294

(22) Filed: Nov. 25, 2014

(30) Foreign Application Priority Data
Dec. 6, 2013 (CN) 201310656069.5

(51) Int. Cl. G06Q 20/40

(52) U.S. Cl. CPC G06Q 20/40

(57) ABSTRACT

Determining a transaction target identifier is disclosed, including: receiving an activation request from a client device, wherein the activation request includes one or more of the following: a requestor identifier, time information associated with the activation request, and location information associated with the activation request; determining a set of candidate transaction target identifiers based at least in part on the one or more of the following: the requestor identifier, the time information associated with the activation request, and the location information associated with the activation request; sending the set of candidate transaction target identifiers to the client device; receiving a selection associated with a transaction target identifier from the set of candidate transaction target identifiers from the client device; and processing the activation request based at least in part on the selected transaction target identifier.

### CROSS REFERENCE TO OTHER APPLICATIONS

This application claims priority to People's Republic of China Patent Application No. 201310656069.5 entitled A METHOD AND SYSTEM FOR OBTAINING OBJECT INFORMATION, filed Dec. 6, 2013 which is incorporated herein by reference for all purposes.

### FIELD OF THE INVENTION

The present application relates to the field of Internet technology. In particular, the present application relates to techniques for determining transaction target information.

### BACKGROUND OF THE INVENTION

As more applications in web technology are created, the need to perform data exchanges between mobile and or non-mobile terminals also increases.

In some situations, the exchanged data includes information associated with a terminal, an application executing at a terminal, and/or a user that is currently logged into the application executing at the terminal. Such information may be referred to as “object information.” Conventionally, such object information is generally only determined by information collected from terminals activated within the same time interval and in the same geographic area. However, conventionally, the accuracy of the activation time interval and geographic information was determined under very strict requirements and as such, if a terminal's location information or its activation time is slightly inaccurate, then it becomes very difficult to locate the desired party for the data exchange.

### BRIEF DESCRIPTION OF THE DRAWINGS

Various embodiments of the invention are disclosed in the following detailed description and the accompanying drawings.

FIG. 1 is a diagram showing an embodiment of a system for determining a transaction target identifier.

FIG. 2 is a flow diagram showing an embodiment of a process for determining a transaction target identifier.

FIG. 3 is a flow diagram showing an example of a process for determining a transaction target identifier.

FIG. 4 is a diagram showing an example of a system for determining a transaction target identifier.

FIG. 5 is a diagram showing an example of a system for determining a transaction target identifier.

FIG. 6 is a diagram showing an example of a system for determining a transaction target identifier.

FIG. 7 is a flow diagram showing an embodiment of a process for determining a transaction target identifier.

FIG. 8 is a diagram showing an example of a system for determining a transaction target identifier.

FIG. 9 is a diagram showing an example of a system for determining a transaction target identifier.

FIG. 10 is a flow diagram showing an embodiment of a process for determining a transaction target identifier.

FIG. 11 is a diagram showing an example of a system for determining a transaction target identifier.

FIG. 12 is a flow diagram showing an embodiment of a process for determining a transaction target identifier.

FIG. 13 is a diagram showing an example of a system for determining a transaction target identifier.

FIG. 14 is a diagram showing an example of a system for determining a transaction target identifier.

FIG. 15 is a flow diagram showing an embodiment of a process for determining a transaction target identifier.

FIG. 16 is a diagram showing an example of a system for determining a transaction target identifier.

FIG. 17 is a flow diagram showing an embodiment of a process for determining a transaction target identifier.

FIG. 18 is a diagram showing an example of a system for determining a transaction target identifier.

FIG. 19 is a diagram showing an example of a system for determining a transaction target identifier.

FIG. 20 is a functional diagram illustrating an embodiment of a programmed computer system for implementing determining a transaction target identifier.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Two users may complete a payment transaction using their respective client devices. For example, a first user initiates a transfer of a payment (e.g., of money or other credit) to a second user. In some instances, the payment transaction may be facilitated by a third party payment service provider, with which each of the two users has registered an account. The third party payment service provider may be operated at least in part on a website and/or provide a server that is configured to facilitate a payment transaction between users. For example, the third party payment service provider may comprise a payment platform. Thus, two or more parties to a payment transaction can complete the payment using the service provided by the payment platform. For example, Alibaba operates such a payment platform.

Client devices can access payment platforms provided by third party payment service providers and use these payment platforms to complete specific payment-related process flows. In addition, to ensure convenience and security, a client device may execute payment using an application (e.g., software) provided by a third party payment service provider to aid a user in performing a payment transaction over the third party payment service. Regardless of whether a client device contacts a payment platform provided by the third party payment service provider with or without such an application, the payment platform requires a first user of a payment transaction to input the identifier of the other one or more users who are also parties to the payment transaction. “Service platforms” will be used herein to represent platforms that comprise third party payment platforms.

Embodiments described herein determine one or more candidate transaction target identifiers from which a user who requested activation can select a transaction target identifier with whom to complete a transaction. In various embodiments, the request for the activation may include one or more of the following: a requestor identifier, time information associated with the activation request, and location information associated with the activation request. Based at least in part on the requestor identifier, time information associated with the activation request, and location information associated with the activation request, one or more candidate transaction target identifiers can be determined and presented at a client device associated with the requestor user. At least one transaction target identifier may be selected from a list of the one or more candidate transaction target identifiers, with whom the transaction is to be processed.

In various embodiments, the requested activation comprises a request for a payment transaction by a user who is a party to that transaction. In order to complete a payment transaction, a service platform requires the correct identifying information of the at least one other party who is also to be involved in the transaction. In various embodiments, the at least two parties involved in a requested transaction include at least one “payee,” a party to whom money and/or other credit is to be paid, and at least one “payer,” a party who is to pay money and/or other credit to a payee. In various embodiments, a “transaction target identifier” comprises at least information identifying one or more other parties who are to be involved in a requested transaction relative to a user who had requested the payment transaction. For example, a user who requests a payment transaction may be a payee or a payer in the transaction and therefore the transaction target identifier to be identified for the transaction may comprise a payer or payee, respectively. In addition, in some embodiments, a “transaction target identifier” may also include information that does not relate to a specific payment.

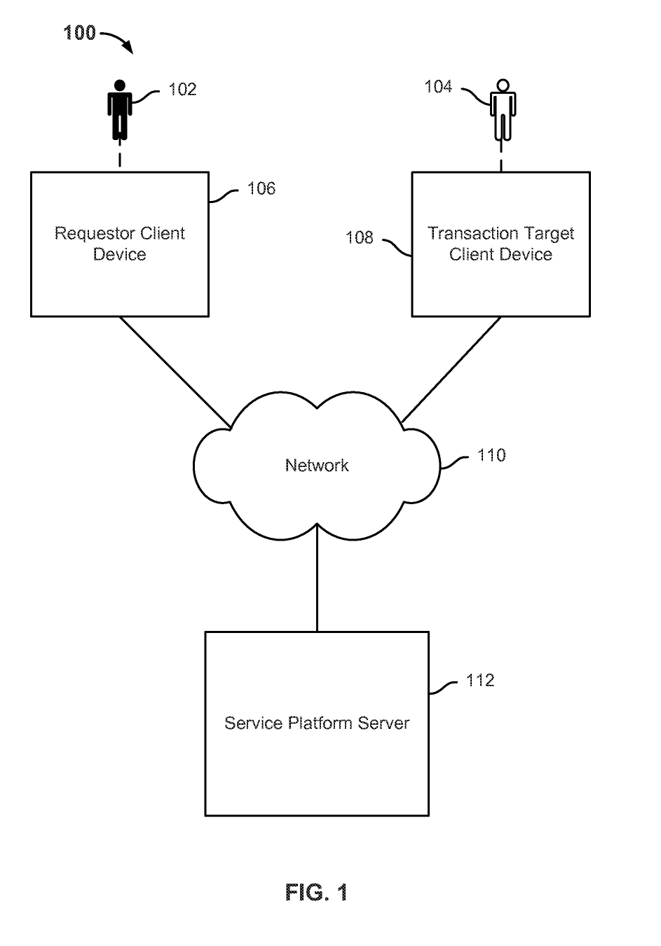

FIG. 1 is a diagram showing an embodiment of a system for determining a transaction target identifier. System 100 includes requestor user 102, requestor client device 106, transaction target user 104, transaction target client device 108, network 110, and service platform server 112. Network 110 includes one or more of high-speed data networks and/or telecommunications networks.

Requestor user 102 comprises a user with an account at a third party payment platform provided by service platform server 112 and transaction target user 104 comprises another user with an account at the third party payment platform provided by service platform server 112. For example, requestor user 102 wishes to send a payment to transaction target user 104. So, requestor user 102 opens an application executing at requestor client device 106 to access the service platform provided by service platform server 112. For example, the application may comprise an (e.g., standalone) application associated with the service platform and/or a web browser that is directed to a website associated with the service platform. Requestor user 102 may log in to the service platform using the application with his or her credentials (e.g., account name and password) and make a selection to issue an activation request to complete a payment transaction. In some embodiments, the application executing at requestor client device 106 may query service platform server 112 over network 110 to obtain a user identifier associated with requestor user 102, also referred to as a “requestor identifier,” based on the input credentials. In various embodiments, the application executing at requestor client device 106 is configured to generate the activation request. In some embodiments, the activation request includes the requestor identifier. In some embodiments, the activation request includes time information associated with the activation request. For example, the time information comprises a timestamp associated with when the application executing at requestor client device 106 had generated the activation request. In some embodiments, the activation request includes location information associated with the activation request. For example, the location information comprises GPS information associated with where requestor client device 106 was located when the application had issued the activation request. Requestor client device 106 is configured to send the activation request to service platform server 112 over network 110.

For example, transaction target user 104 wishes to receive a payment from requestor user 102 and so opens an application executing at transaction target client device 108 to access the service platform provided by service platform server 112. Transaction target user 104 can log into the service platform using an application executing at transaction target client device 108 to initiate a request (an activation type of request or a different type of request). In various embodiments, the application executing at transaction target client device 108 is configured to generate the request. In some embodiments, the activation request includes a user identifier associated with transaction target user 104. In some embodiments, the request issued by the application executing at transaction target client device 108 includes time information associated with the request and/or location information associated with the request. Transaction target client device 108 is configured to send the request to service platform server 112 over network 110.

As will be described in embodiments described below, service platform server 112 and/or requestor client device 106 is configured to use the requestor identifier, time information associated with the activation request, and location information associated with the activation request to determine a set of candidate transaction target identifiers to be presented at requestor client device 106. Depending on whether the user identifier, time information, and/or location information associated with the request issued by the application executing at transaction target client device 108 meets the criteria generated based on the requestor identifier, time information associated with the activation request, and location information associated with the activation request, the user identifier of transaction target user 104 will be included in the set of candidate transaction target identifiers that is presented at requestor client device 106.

In response to the presentation of the set of candidate transaction target identifiers at requestor client device 106, requestor user 102 is configured to select at least one transaction target identifier from the set, including, potentially, the user identifier of transaction target user 104.

As such, service platform server 112 is configured to infer a list of candidate transaction target identifiers for requestor user 102 based on at least the data included in the activation request received from requestor client device 106. This way, requestor user 102 does not need to memorize the user identifier of transaction target user 104, which may comprise a lengthy payment account number, in order to complete a transaction with the other user but that the user identifier of transaction target user 104 and the user identifiers of other users may be automatically discovered given the activation request from requestor client device 106 and returned to requestor client device 106.

After requestor user 102 selects at least one transaction target identifier from the set of candidate transaction target identifiers, requestor client device 106 is configured to send the selection(s) back to service platform server 112, which will process the activation request based at least in part on the selections, as will be described in further detail below.

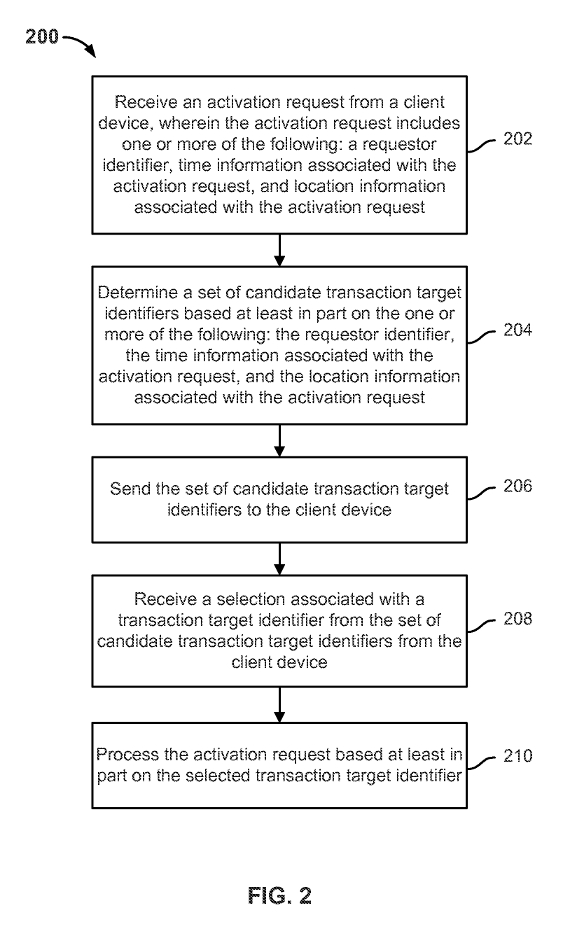

FIG. 2 is a flow diagram showing an embodiment of a process for determining a transaction target identifier. In some embodiments, process 200 is implemented at system 100 of FIG. 1.

At 202, an activation request is received from a client device, wherein the activation request includes one or more of the following: a requestor identifier, time information associated with the activation request, and location information associated with the activation request.

An application executing at a client device can be used to issue an activation request on behalf of a user. In some embodiments, the application is associated with a service platform. In some embodiments, the application comprises a web browser application that is directed to a website associated with the service platform. A user who has previously registered an account with the service platform may submit his or her credentials (e.g., an account name that uniquely identifies the user and his or her password) to the application and the application will determine identifying information associated with the user. For example, the identifying information may be a payment account number stored by the service platform corresponding to the user associated with the submitted account name. After logging into the service platform, the user may submit an activation request to complete a transaction. The client device then sends the activation request to a service associated with the service platform.

In some embodiments, an activation request issued by the application is a request to activate a payment transaction. For example, the user who is logged in at the client device may desire to either send a payment to or receive a payment from one or more other users.

In some embodiments, the activation request issued by the application to activate the payment process may contain a “requestor identifier” of the user who has logged into that application, the user associated with issuing the activation request. In some embodiments, the requestor identifier of the logged in user comprises the payment account number of the logged in user. In some embodiments, after the user has logged into the service platform with the application, the application automatically determines the payment account number stored by the service platform for the logged in user and includes the payment account number in the activation request as the requestor identifier.

In some embodiments, the user associated with issuing the activation request may also input his or her role with respect to the transaction. If the transaction comprises a payment transaction, then the user may indicate that he or she is a “payer” or “payee” role with respect to the payment transaction. The user's specified role may optionally be included in the activation request, in some embodiments.

In some embodiments, the activation request issued by the application to activate the payment process may contain location information of the client device and also time information associated with the request. In some embodiments, the location information of the client device and time information associated with the request can be determined in a related manner. The following are three example techniques by which to determine the location information of the client device and also time information associated with the request:

In a first example, the location information of the client device can be the positioning coordinate information of the client device as recorded by a positioning functionality that is a part of the client device. For example, common positioning functionalities might make use of the United States Global Positioning System (GPS) satellite navigation system, Europe's Galileo satellite navigation system, Russia's GLONASS satellite navigation system, China's Beidou satellite navigation system, or any other navigation system. Positioning coordinate information of this sort is sometimes referred to as “mobile positioning.” In this first example, the time information associated with the activation request comprises a login timestamp that is determined by the application executing at the client device at the time that the application issued the activation request.

In a second example, the location information can be converted by the network equipment of the wireless carrier from signal characteristics based on the client device. For example, a wireless carrier uses base station coverage principles to calculate location information from the signals of the client device through base station positioning. In the positioning calculations of the second example, generally, client devices measure the downlink pilot signals of different base stations to obtain downlink pilot time of arrival (TOA) or time difference of arrival (TDOA) of different base stations. Given the measurement results and base station coordinates, the location of the client device can generally be calculated using a triangulation formula estimation algorithm. The actual location estimation algorithm needs to take into account the positioning of multiple base stations (three or more, for example). Generally, the greater the number of base stations that are used for mobile station measurement, the more precise the measurements will be and the more obvious the improvements in positioning performance will be. In the second example, the time information associated with the request comprises a login timestamp that is marked by a wireless carrier when the activation request is received by the carrier.

Being based on the clocks of wireless carriers, the time information associated with the request as described in the second example is basically all the same, and there is not much chance of error in the login timestamps among activation requests issued by different client devices. If the time information as described in the first example is recorded by each client device according to its own clock, then there is a somewhat larger chance of timing error among activation requests issued by different client devices.

In a third example, the location information can be determined by a combination of the first and second examples described above.

In some embodiments, the client device's location information and time information contained in the activation request received by the service platform could be a combination of the location information as described in the first example above and the time information as described in the second example above, or it could be a combination of the location information as described in the second example above and the time information as described in the first example above.

In some embodiments, the time information associated with the activation request may be a timestamp that is determined by the service platform when it receives the issued request and then the service platform may include the timestamp in the request. Where the activation request is for a payment transaction, because the service platform needs to consider payment-related time intervals, the service platform will uniformly record login timestamps of various received activation requests. As such, by allowing the service platform to determine the time information for each received activation request, there is relatively little chance of timing errors being assigned to the requests.

At 204, a set of candidate transaction target identifiers is determined based at least in part on the one or more of the following: the requestor identifier, the time information associated with the activation request, and the location information associated with the activation request.

A set of candidate transaction target identifiers can be determined using various techniques based on the requestor identifier, the time information associated with the activation request, and the location information associated with the activation request.

In some embodiments, a first set of user identifiers associated with other logged in users is determined based on the time information associated with the activation request. Each user identifier of the first set may comprise a unique payment account number stored by the service platform. The time information associated with the activation request can be classified in a time interval based on a predetermined interval (e.g., each interval is configured to be one hour long or several minutes long) and the identifiers of other users who have also logged in to the service platform during the same time interval can be determined as a first set of user identifiers.

In some embodiments, a second set of user identifiers associated with other logged in users is determined based on the location information associated with the activation request. Each user identifier of the second set may comprise a unique payment account number stored by the service platform. Identifiers of other users who have also logged in to the service platform within a predetermined range (e.g., a range of a certain distance) from the location information associated with the activation request can be determined as a second set of user identifiers.

In some embodiments, a third set of user identifiers associated with other logged in users is determined based on the requestor identifier of the activation request. Each user identifier of the third set may comprise a unique payment account number stored by the service platform. Identifiers of other users who have had a historical relationship with the requestor identifier in the activation request can be determined as a third set of user identifiers. For example, a historical relationship between two user identifiers comprises the two user identifiers who have previously both been parties to a past payment transaction.

As will be described in embodiments below, a set of candidate transaction target identifiers may be determined as the one or more user identifiers that simultaneously exist in (are common to) each of two or more of the following: the first set of user identifiers, the second set of user identifiers, and the third set of user identifiers, as described above. As such, by finding common user identifiers across two more sets of user identifiers that are each related to the activation request in a different manner, the resulting set of candidate transaction target identifiers is more likely to include the correct one or more parties to the desired transaction associated with the activation request.

As will be described in various examples below, one or more of the requestor identifier, the time information associated with the activation request, and the location information associated with the activation request can be used to generate criteria that a user identifier must meet in order to be considered a candidate target transaction identifier.

At 206, the set of candidate transaction target identifiers is sent to the client device.

The set of candidate transaction target identifiers is sent to the client device.

At 208, a selection associated with a transaction target identifier from the set of candidate transaction target identifiers is received from the client device.

The set of candidate transaction target identifiers may be presented by the application at the client device as a list of transaction target identifiers, each of which may be displayed as a payment account number and/or other identifying information associated with the corresponding user. The user who had initiated the activation request from the client device may select at least one transaction target identifier from the set of candidate transaction target identifiers. The selected at least one transaction target identifier from the set of candidate transaction target identifiers identifies the corresponding one or more other users with whom the user who initiated the activation request from the client device wishes to complete the transaction.

In some embodiments, along with the selection of each transaction target identifier from the list, the user associated with issuing the activation request may also input a role associated with each selected transaction target identifier with respect to the transaction. If the transaction comprises a payment transaction, then the user may indicate that each selected transaction target identifier comprises a “payer” or “payee” role with respect to the payment transaction. Each selected transaction target identifier's specified role may optionally be sent back to the service platform server, in some embodiments.

At 210, the activation request is processed based at least in part on the selected transaction target identifier.

Where the activation request is associated with a payment transaction, the user initiating the activation request from the client device may indicate whether he or she would like to send a specified amount of money (or other credit) to the transaction target identifier(s) or receive a specified amount of money (or other credit) from the transaction target identifier(s).

In some embodiments, where roles were specified for the requestor identifier and each selected transaction target identifier with respect to the transaction, the roles are also used to complete the transaction.

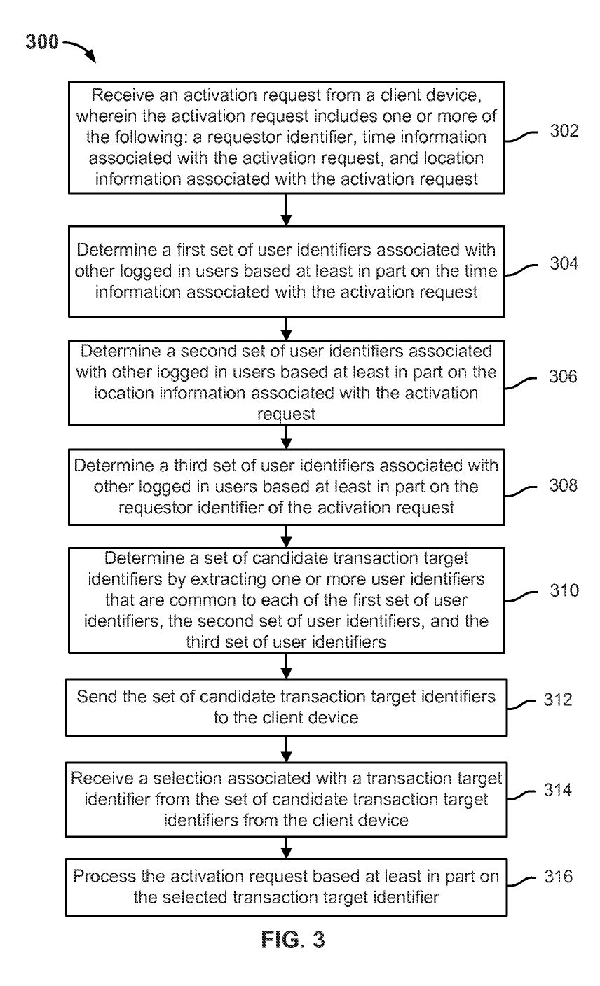

FIG. 3 is a flow diagram showing an example of a process for determining a transaction target identifier. In some embodiments, process 300 is implemented at system 100 of FIG. 1. In some embodiments, process 200 of FIG. 2 is implemented using process 300.

At 302, an activation request is received from a client device, wherein the activation request includes one or more of the following: a requestor identifier, time information associated with the activation request, and location information associated with the activation request.

At 304, a first set of user identifiers associated with other logged in users is determined based at least in part on the time information associated with the activation request.

Each user identifier of the first set may comprise a unique payment account number stored by the service platform. The time information associated with the activation request can be classified in a time interval based on a predetermined interval and the identifiers of other users who have also logged in to the service platform during the same time interval can be determined as a first set of user identifiers. For example, the time information associated with the activation request may be classified into a time interval based on a certain number of minutes before and/or after the time information associated with the activation request. For instance, if the predetermined time interval were defined as being 5 minutes before and after the time information associated with the activation request, which was 11:02 am, then the time interval associated with the activation request would be 10:57 am through 11:07 am.

In some embodiments, these other users can be users who have logged into the service platform using client devices other than the client device from which the activation request of step 302 was received. In some embodiments, in order to be considered to be included in the first set of user identifiers, a user is required to have logged in to the service platform using another client device and also to have sent an activation request to the service platform to complete a transaction. In some embodiments, in order to be considered to be included in the first set of user identifiers, a user is required to have logged in to the service platform using another client device and to have sent a type of request other than an activation request to the service platform. The requests (activation requests or other types of requests) associated with the other users may include respective time information, which is used to determine the time interval associated with each such user. The requests (activation requests or other types of requests) associated with the other users may also include respective location information, which is used to determine the location associated with each such user, as will be described below. There could be a number of other users associated with the same time interval as the activation request of step 302 because most of these users may have logged in to the service platform expecting to complete a transaction other than the one associated with the activation request of step 302.

For example, a user identified by a first payment account number logs into the service platform via an application executing at a first client device. This user initiates an activation request, which is to activate a payment transaction, for example. The time information of this activation request is identified. In the majority of payment situations, it is expected that the one or more other payment account numbers that are also parties to this payment transaction will also log in or would have logged in to the service platform within a few minutes of the first payment account number having done so. Therefore, in some embodiments, the time interval by which to identify other users to the payment transaction is generally configured to be a relatively short length of time. In some embodiments, the specific time length to configure as the time interval can be set according to statistical analysis of existing big data. For example, the determined time interval should contain the timestamp indicated by the activation request of the first payment account number. For example, one example of determining the time interval of the first payment account number is to use the timestamp indicated by the activation request as the center and then to extend it forward and backward in time by 2 to 3 minutes.

At 306, a second set of user identifiers associated with other logged in users is determined based at least in part on the location information associated with the activation request.

Each user identifier of the second set may comprise a unique payment account number stored by the service platform. Identifiers of other users who have also logged in to the service platform within a predetermined range from the location information associated with the activation request can be determined as a second set of user identifiers. In some embodiments, these other users can be users who have logged into the service platform using client devices other than the one from which the activation request of step 302 was received. In some embodiments, users can be considered to be included in the second set of user identifiers if they meet the same requirements as described above for being considered to be included in the first set of user identifiers at step 304.

The service platform may record a set of user identifiers activated within each a time interval. This time interval may be the same or different length of time than was determined for step 304. Where each activation request activates a payment transaction, the service platform may store information on all requests (activation or other types of requests) that are associated with a certain time interval but whose payment transactions have not yet been processed. For example, such a time interval may be configured to be a number of days, hours, or minutes. Moreover, the location information included in the requests sent by these user identifiers is obtained.

As mentioned before, identifiers of other users who have also logged in to the service platform within a predetermined range (e.g., distance) from the location information associated with the activation request can be determined as a second set of user identifiers. By configuring a reasonable range (e.g., radius of distance) relative to the location information (e.g., a GPS coordinate) associated with the activation request, it may be possible to discover all the users in the vicinity of the user who initiated the activation request that are party to the payment transaction requested to be activated by the requestor identifier. For example, all users who have logged in to the service platform within the predetermined range of the “Huamao Shopping Mall” may be determined as being included within the predetermined range of the location information included in the activation request that identifies the “Huamao Shopping Mall.”

In this way, other users who had logged into the service platform within a certain time interval but whose respective payment transactions had not yet been processed can be screened for only those whose location information are within a predetermined range of the location information associated with the activation request of step 302. There could be a number of other users whose location information is within a predetermined range of the location information associated with the activation request of step 302 because most of these users may have logged in to the service platform expecting to complete a transaction other than the one associated with the activation request of step 302.

At 308, a third set of user identifiers associated with other logged in users is determined based at least in part on the requestor identifier of the activation request.

Each user identifier of the third set may comprise a unique payment account number stored by the service platform. Identifiers of other users who have had a historical relationship with the requestor identifier in the activation request can be determined as a third set of user identifiers. For example, a historical relationship between two user identifiers comprises the two user identifiers who have both previously been parties to a historical payment transaction.

The requestor identifier associated with the activation request, comprising a first payment account number, may have been involved in previous payment transactions at the service platform which received the activation request at step 302 and/or other service platforms. Thus, the other payment parties (identified by their corresponding payment account numbers) that were involved in these historical payment transactions with the first payment account number are considered to be historically related to the first payment account number. Thus, historical records of payment processes that included the requestor identifier can be used to determine those user identifiers (payment account numbers) that are related to the requestor identifier. In some embodiments, the client device may record the historical payment transactions associated with each user identifier who has logged into the service platform, determine the payment account numbers that are related to this user identifier, and transmit the related payment account numbers to the service platform. For example, a user may use an application executing at a client device to manually edit/input another payment account number to which he or she is related. After editing it, the request saves it to the service platform. Users to whom the requestor identifier is related (e.g., through previous payment transactions) are more likely to be involved in current payment transactions of the activation request (than a user to whom the requestor identifier is not related).

In some embodiments, identifiers of users who are related to the requestor identifier on a platform other than the service platform that received the activation request at step 302 can be included in the third set of user identifiers. For example, identifiers associated with users with established relationships to the requestor identifier in an instant messaging system or in a social networking system such as a microblog or blog system outside of the service platform may be included in the third set of user identifiers. Such relationships might be indirect relative to the service platform but can still be recognized by the service platform. In some embodiments, the identifiers of users who are related to the requestor identifier on a platform other than the service platform may have corresponding payment account numbers at the service platform and such payment account numbers can be used as the user identifiers of the third set of user identifiers.

Steps 304, 306, and 308 as described above can be implemented in any sequence and, in some embodiments, at least partially in parallel to one another.

At 310, a set of candidate transaction target identifiers is determined by extracting one or more user identifiers that are common to each of the first set of user identifiers, the second set of user identifiers, and the third set of user identifiers.

One or more user identifiers that are simultaneously found in each of the first set of user identifiers, the second set of user identifiers, and the third set of user identifiers are extracted and used as the set of candidate transaction target identifiers. For example, if the first set of user identifiers includes users A, B, C, and D; the second set of user identifiers includes: B, C, D, E, and F; and the third set of user identifiers includes: B, D, F, and G, then users B and D, which are simultaneously found in all three sets of user identifiers, would be extracted and included in the set of candidate transaction target identifiers.

A user identifier that simultaneously exists in the first set of user identifiers, in the second set of user identifiers, and the third set of user identifiers comprises a user who has logged into the service platform in the same time interval as the requestor identifier, within a predetermined range as the requestor identifier, and is also related to the requestor identifier and is therefore inferred to be a likely strong candidate for the transaction requested to be activated by the requestor identifier who had initiated the activation request of step 302. Whether a user identifier has a historical relationship with the requestor identifier can be used to limit the list of candidate transaction target identifiers in the event that errors are present with respect to the time and location information associated with the activation request. Each of the requestor identifier, the time information, and the location information of the activation request can be thought of as being used as a criterion to determine whether a user identifier should be considered as a candidate transaction target identifier.

At 312, the set of candidate transaction target identifiers is sent to the client device.

The set of candidate transaction target identifiers is sent to the client device. For example, the user using the client device can easily select from the returned set of candidate transaction target identifiers (e.g., payment account numbers) the transaction target identifier (e.g., payment account number) with whom he or she expects to complete the transaction.

For example, process 300 may be used where parties participating in a payment transaction are each using a mobile client device. For example, two (or more) parties that are related in some way may wish to complete payment in each other's presence. An activation request to complete a payment transaction is issued from each party's client device, each request with a corresponding payment account number of the respective requestor identifier. At least some of such payment account numbers may request to transfer a specific amount of money (or other credit) into a payment account of a different user. In this situation, the client device of each party to the same payment transaction is located near one another and is issuing requests to activate the payment transaction within the same time interval. If all the accounts involved in this payment transaction have a certain relationship with each other, such as a friendship relationship established at a social media system or at the service platform, process 300 can be used to conveniently infer the candidate transaction target identifiers associated with this payment transaction for each party.

At 314, a selection associated with a transaction target identifier from the set of candidate transaction target identifiers is received from the client device.

At 316, the activation request is processed based at least in part on the selected transaction target identifier.

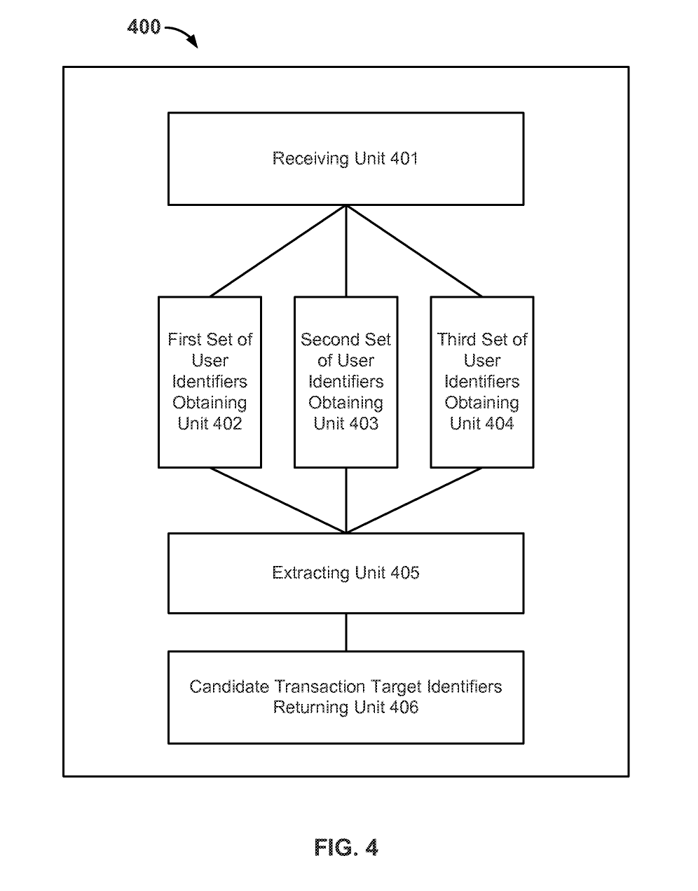

FIG. 4 is a diagram showing an example of a system for determining a transaction target identifier. In some embodiments, process 300 of FIG. 3 is implemented at system 400 of FIG. 4. In the example, system 400 includes receiving unit 401, first set of user identifiers obtaining unit 402, second set of user identifiers obtaining unit 403, third set of user identifiers obtaining unit 404, extracting unit 405, and candidate transaction target identifiers returning unit 406.

The units can be implemented as software components executing on one or more processors, as hardware such as programmable logic devices, and/or Application Specific Integrated Circuits designed to elements can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices.

Receiving unit 401 is configured to receive an activation request issued from a client device. In some embodiments, the activation request includes one or more of the following: a requestor identifier, time information associated with the activation request, and location information associated with the activation request.

First set of user identifiers obtaining unit 402 is configured to determine a first set of user identifiers associated with other logged in users based at least in part on the time information associated with the activation request.

Second set of user identifiers obtaining unit 403 is configured to determine a second set of user identifiers associated with other logged in users based at least in part on the location information associated with the activation request.

Third set of user identifiers obtaining unit 404 is configured to determine a third set of user identifiers associated with other logged in users based at least in part on the requestor identifier of the activation request.

Extracting unit 405 is configured to determine a set of candidate transaction target identifiers by extracting user identifiers that are common to/present in each of the first set of user identifiers, the second set of user identifiers, and the third set of user identifiers.

Candidate transaction target identifiers returning unit 406 is configured to send the set of candidate transaction target identifiers back to the client device. In some embodiments, candidate transaction target identifiers returning unit 406 is also configured to receive at least one selected transaction target identifier from the client device and process the activation request based at least in part on the selected transaction target identifier.

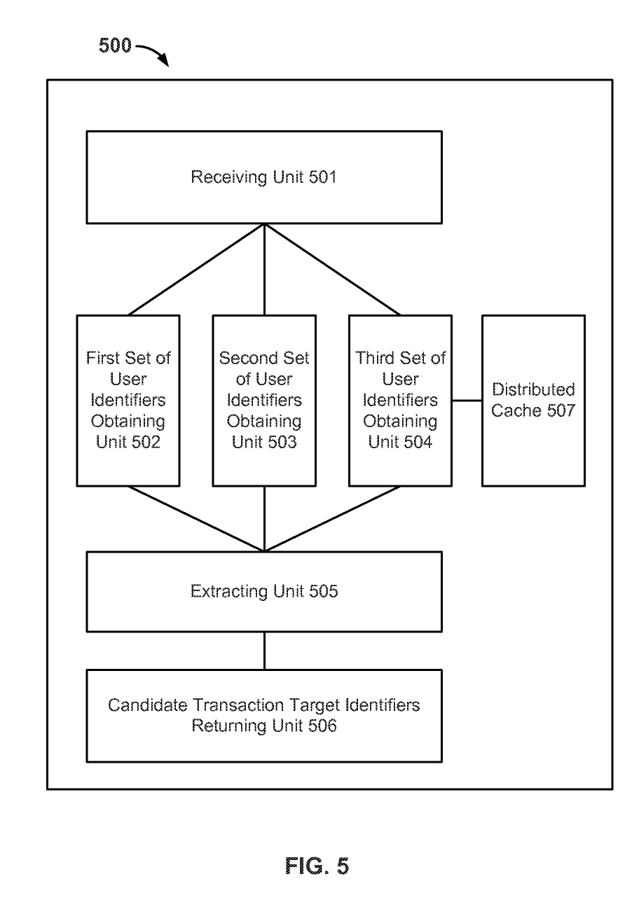

In some embodiments, the third set of user identifiers may be stored in a specific distributed cache on a service platform. In actual implementation, online service providers may regularly use distributed caches to improve high-speed response capability. FIG. 5, below, shows an example of a system for determining a transaction target identifier that uses a distributed cache to store the third set of user identifiers determined for various users.

FIG. 5 is a diagram showing an example of a system for determining a transaction target identifier. In some embodiments, process 300 of FIG. 3 is implemented at system 500 of FIG. 5. In the example, system 500 includes receiving unit 501, first set of user identifiers obtaining unit 502, second set of user identifiers obtaining unit 503, third set of user identifiers obtaining unit 504, extracting unit 505, candidate transaction target identifiers returning unit 506, and distributed cache 507.

The units can be implemented as software components executing on one or more processors, as hardware such as programmable logic devices, and/or Application Specific Integrated Circuits designed to elements can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices.

Receiving unit 501 can be implemented similarly to receiving unit 401 of system 400 of FIG. 4. First set of user identifiers obtaining unit 502 can be implemented similarly to first set of user identifiers obtaining unit 402 of system 400 of FIG. 4. Second set of user identifiers obtaining unit 503 can be implemented similarly to second set of user identifiers obtaining unit 403 of system 400 of FIG. 4.

Distributed cache 507 is configured to store records that indicate relationships between user identifiers.

Third set of user identifiers obtaining unit 504 is configured to query distributed cache 507 for a third set of user identifiers associated with other logged in users based at least in part on the requestor identifier of the activation request.

Extracting unit 505 can be implemented similarly to first set of user identifiers extracting unit 405 of system 400 of FIG. 4. Candidate transaction target identifiers returning unit 506 can be implemented similarly to candidate transaction target identifiers returning unit 406 of system 400 of FIG. 4.

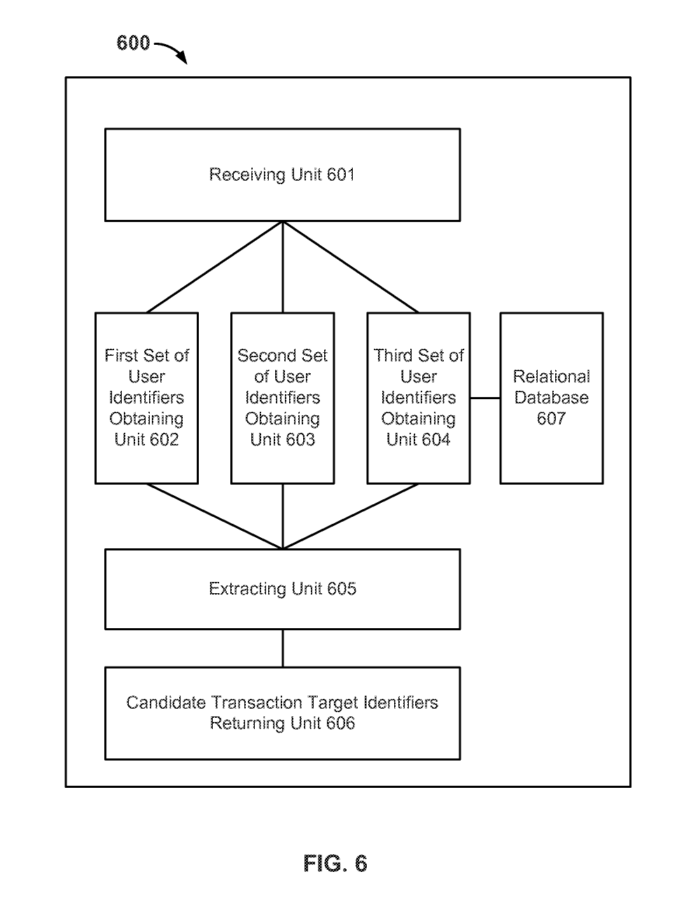

In some embodiments, the third set of user identifiers may be stored in a specialized relational database that is located on a single specialized server. FIG. 6, below, shows an example of a system for determining a transaction target identifier that uses a relational database to store the third set of user identifiers determined for various users.

FIG. 6 is a diagram showing an example of a system for determining a transaction target identifier. In the example, system 600 includes receiving unit 601, first set of user identifiers obtaining unit 602, second set of user identifiers obtaining unit 603, third set of user identifiers obtaining unit 604, extracting unit 605, candidate transaction target identifiers returning unit 606, and relational database 607.

The units can be implemented as software components executing on one or more processors, as hardware such as programmable logic devices, and/or Application Specific Integrated Circuits designed to elements can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices.

Receiving unit 601 can be implemented similarly to receiving unit 401 of system 400 of FIG. 4. First set of user identifiers obtaining unit 602 can be implemented similarly to first set of user identifiers obtaining unit 402 of system 400 of FIG. 4. Second set of user identifiers obtaining unit 603 can be implemented similarly to second set of user identifiers obtaining unit 403 of system 400 of FIG. 4.

Relational database 607 is configured to store records that indicate relationships between user identifiers.

Third set of user identifiers obtaining unit 604 is configured to query relational database 607 for a third set of user identifiers associated with other logged in users based at least in part on the requestor identifier of the activation request.

Extracting unit 605 can be implemented similarly to first set of user identifiers extracting unit 405 of system 400 of FIG. 4. Candidate transaction target identifiers returning unit 606 can be implemented similarly to candidate transaction target identifiers returning unit 406 of system 400 of FIG. 4.

In some embodiments, a distributed cache and a relational database might both be included in a system for determining transaction target identifiers in order to provide both high data access speed and centralized management of big data. The third set of user identifiers obtaining unit may give priority to obtaining the third set of user identifiers from the distributed cache. If the third set of user identifiers cannot be obtained from the distributed cache, the third set of user identifiers obtaining unit may then choose to obtain the third set of user identifiers from the relational database. If the third set of user identifiers is acquired successfully from the relational database, then a copy of the third set of user identifiers can be saved in the distributed cache for rapid response of future processes, e.g., rapid response of future payment processes.

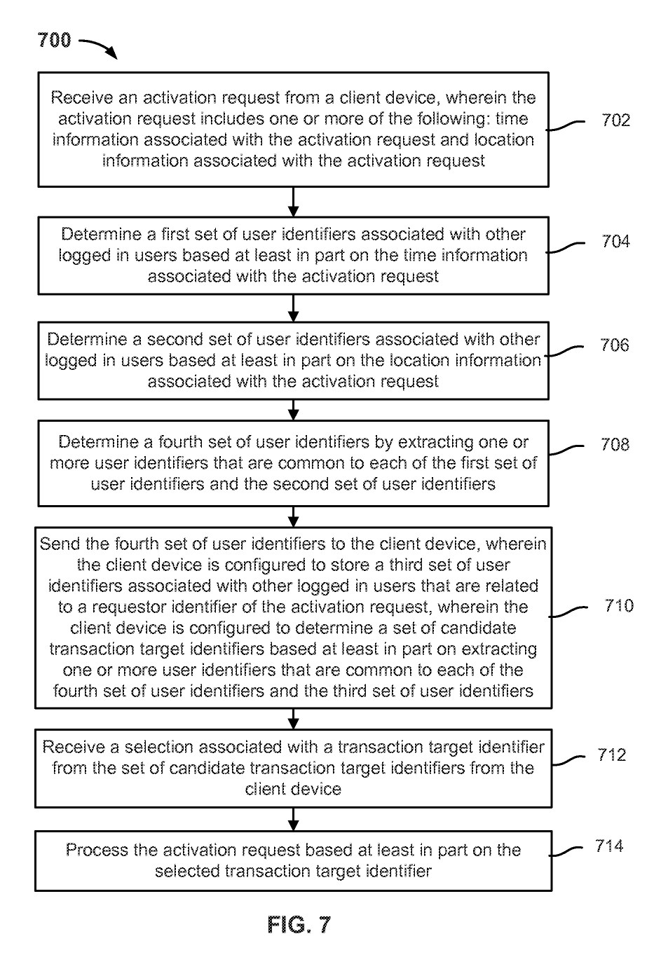

FIG. 7 is a flow diagram showing an embodiment of a process for determining a transaction target identifier. In some embodiments, process 700 is implemented at system 100 of FIG. 1. In some embodiments, process 200 of FIG. 2 is implemented using process 700.

At 702, an activation request is received from a client device, wherein the activation request includes one or more of the following: time information associated with the activation request and location information associated with the activation request. In some embodiments, the requestor identifier is optionally included in the activation request.

At 704, a first set of user identifiers associated with other logged in users is determined based at least in part on the time information associated with the activation request.

At 706, a second set of user identifiers associated with other logged in users is determined based at least in part on the location information associated with the activation request.

At 708, a fourth set of user identifiers is determined by extracting one or more user identifiers that are common to each of the first set of user identifiers and the second set of user identifiers. One or more user identifiers that are simultaneously found in each of the first set of user identifiers and the second set of user identifiers are extracted and included in a further set of user identifiers. The fourth set of user identifiers that appear in both the first set of user identifiers and the second set of user identifiers comprises user identifiers that have logged in (and/or sent requests) to the service platform close in time and location to the activation request of step 702.

At 710, the fourth set of user identifiers is sent to the client device, wherein the client device is configured to store a third set of user identifiers associated with other logged in users that are related to a requestor identifier of the activation request, wherein the client device is configured to determine a set of candidate transaction target identifiers based at least in part on extracting one or more user identifiers that are common to each of the fourth set of user identifiers and the third set of user identifiers.

In process 700, the client device itself either stores and/or has access to the third set of user identifiers that includes user identifiers who have had historical relationships with the requestor identifier. As such, the client device may determine on its own, which user identifiers of the fourth set of user identifiers (that comprise user identifiers that have logged in (and/or sent requests) to the service platform close in time and location to the activation request of step 702) are also user identifiers who have had a relationship with the requestor identifier. Therefore, the client device can determine on its own which user identifiers have logged in (and/or sent requests) to the service platform close in time and location to the activation request of step 702 and are also related to the requestor identifier and should therefore be included in the set of candidate transaction target identifiers. The set of candidate transaction target identifiers can be presented at the client device.

At 712, a selection associated with a transaction target identifier from the set of candidate transaction target identifiers is received from the client device.

At 714, the activation request is processed based at least in part on the selected transaction target identifier.

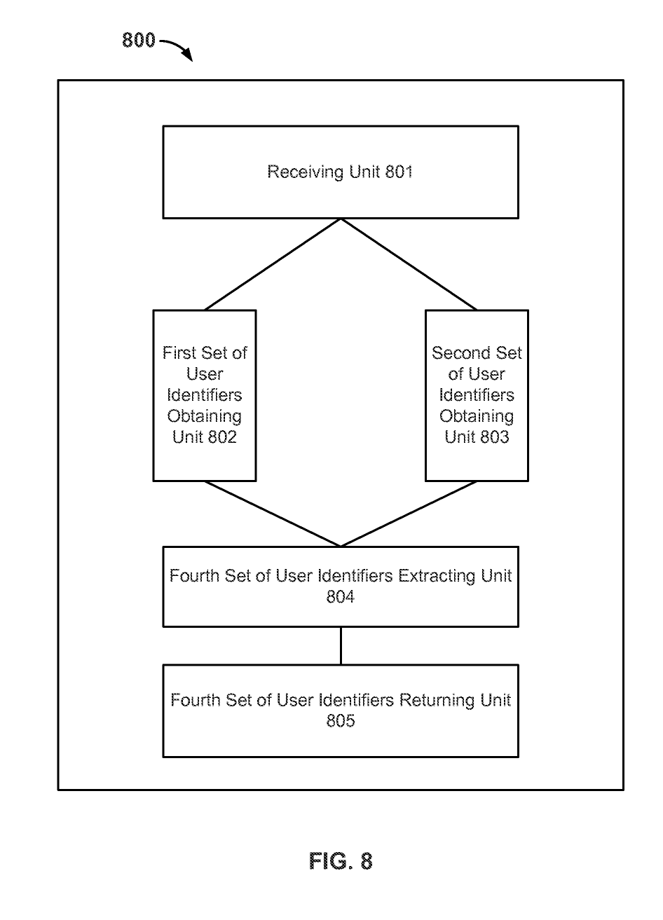

FIG. 8 is a diagram showing an example of a system for determining a transaction target identifier. In some embodiments, system 800 comprises a server associated with a service platform. In some embodiments, process 700 of FIG. 7 is implemented at system 800 of FIG. 8. In the example, system 800 includes receiving unit 801, first set of user identifiers obtaining unit 802, second set of user identifiers obtaining unit 803, fourth set of user identifiers extracting unit 804, and fourth set of user identifiers returning unit 805.

The units can be implemented as software components executing on one or more processors, as hardware such as programmable logic devices, and/or Application Specific Integrated Circuits designed to elements can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices.

Receiving unit 801 is configured to receive an activation request issued from a client device. In some embodiments, the activation request includes one or both of the time information associated with the activation request and location information associated with the activation request. The activation request optionally includes the requestor identifier.

First set of user identifiers obtaining unit 802 is configured to determine a first set of user identifiers associated with other logged in users based at least in part on the time information associated with the activation request.

Second set of user identifiers obtaining unit 803 is configured to determine a second set of user identifiers associated with other logged in users based at least in part on the location information associated with the activation request.

Fourth set of user identifiers extracting unit 804 is configured to determine a fourth set of user identifiers by extracting user identifiers that are common to/simultaneously present in each of the first set of user identifiers and the second set of user identifiers.

Fourth set of user identifiers returning unit 805 is configured to send the fourth set of user identifiers to the client device. In some embodiments, fourth set of user identifiers returning unit 805 is also configured to receive at least one selected transaction target identifier from the client device and process the activation request based at least in part on the selected transaction target identifier.

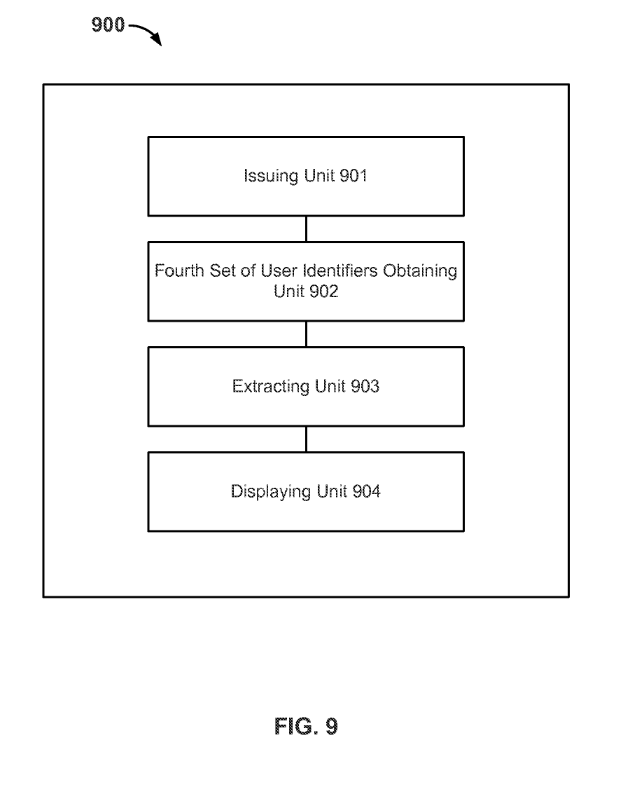

FIG. 9 is a diagram showing an example of a system for determining a transaction target identifier. In some embodiments, system 900 comprises a client device. In the example, system 900 includes issuing unit 901, fourth set of user identifiers obtaining unit 902, extracting unit 903, and displaying unit 904.

The units can be implemented as software components executing on one or more processors, as hardware such as programmable logic devices, and/or Application Specific Integrated Circuits designed to elements can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices.

Issuing unit 901 is configured to send an issued activation request to a service platform server (e.g., system 800 of FIG. 8). In some embodiments, the activation request includes one or both of the time information associated with the activation request and location information associated with the activation request. The activation request optionally includes the requestor identifier.

Fourth set of user identifiers obtaining unit 902 is configured to receive a fourth set of user identifiers from the service platform server. The fourth set of user identifiers includes user identifiers that were common to/simultaneously present in each of a first set of user identifiers determined based on the time information included in the activation request and the second set of user identifiers determined based on the location information included in the activation request.

Extracting unit 903 is configured to determine a set of candidate transaction target identifiers based at least in part on extracting one or more user identifiers that are simultaneously present in each of the fourth set of user identifiers and a third set of user identifiers. The third set of user identifiers is stored at the client device and includes user identifiers that are related to the requestor identifier of the activation request.

Displaying unit 904 is configured to display the set of candidate transaction target identifiers at a user interface. In some embodiments, displaying unit 904 is also configured to receive at least one selection of a transaction target identifier via the user interface and send the selection to the service platform server.

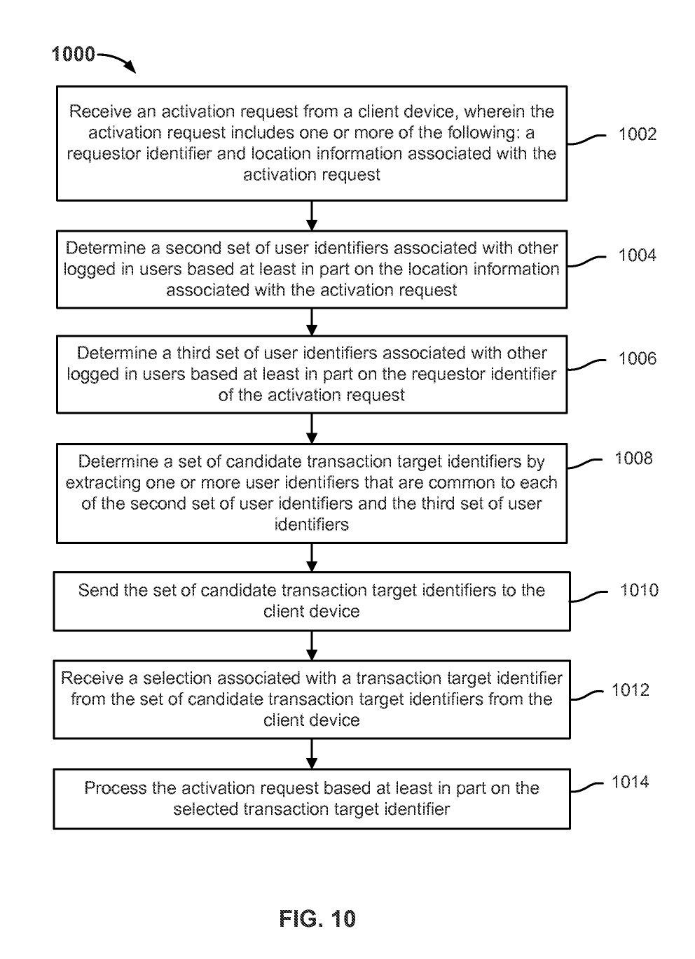

FIG. 10 is a flow diagram showing an embodiment of a process for determining a transaction target identifier. In some embodiments, process 1000 is implemented at system 100 of FIG. 1. In some embodiments, process 200 of FIG. 2 is implemented using process 1000.

At 1002, an activation request is received from a client device, wherein the activation request includes one or more of the following: a requestor identifier and location information associated with the activation request. In some embodiments, the time information associated with the activation request is optionally included in the activation request.

At 1004, a second set of user identifiers associated with other logged in users is determined based at least in part on the location information associated with the activation request.

At 1006, a third set of user identifiers associated with other logged in users is determined based at least in part on the requestor identifier of the activation request.

At 1008, a set of candidate transaction target identifiers is determined by extracting one or more user identifiers that are common to each of the second set of user identifiers and the third set of user identifiers.

At 1010, the set of candidate transaction target identifiers is sent to the client device.

At 1012, a selection associated with a transaction target identifier from the set of candidate transaction target identifiers is received from the client device.

At 1014, the activation request is processed based at least in part on the selected transaction target identifier.

In the example of process 1000, the time information associated with the activation request is not considered in determining the set of candidate transaction target identifiers. Put another way, the time information associated with the activation request is not a constraint/criterion used in determining the set of candidate transaction target identifiers in process 1000. By removing the constraint/criterion of finding candidate transaction target identifiers that are associated with the same time interval as the time information associated with the activation request, the correct party to the requested transaction who may be associated with a different time interval is not precluded from being determined as part of the set of candidate transaction target identifiers. For example, a requestor identifier activates a payment process at a certain time and in a certain location area, and if the other party to the payment activated the payment process within the same location area but one hour earlier, using process 1000, this other party may still be identified as a candidate transaction target identifier even though the other party is not indicated as being within the same time interval as the requestor identifier. As such, process 1000 provides greater time-related flexibility in identifying the set of candidate transaction target identifiers.

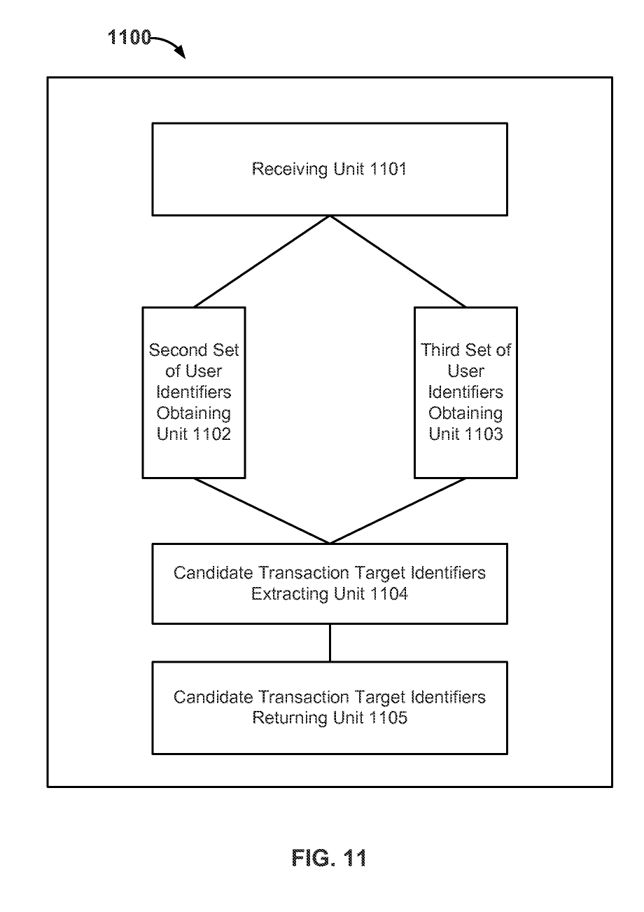

FIG. 11 is a diagram showing an example of a system for determining a transaction target identifier. In some embodiments, process 1000 is implemented at system 1100 of FIG. 11. In the example, system 1100 includes receiving unit 1101, second set of user identifiers obtaining unit 1102, third set of user identifiers obtaining unit 1103, extracting unit 1104, and candidate transaction target identifiers returning unit 1105.

The units can be implemented as software components executing on one or more processors, as hardware such as programmable logic devices, and/or Application Specific Integrated Circuits designed to elements can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices.

Receiving unit 1101 is configured to receive an activation request issued from a client device. In some embodiments, the activation request includes one or more of the following: a requestor identifier and location information associated with the activation request. In some embodiments, time information associated with the activation request can be optionally included in the request.

Second set of user identifiers obtaining unit 1102 is configured to determine a second set of user identifiers associated with other logged in users based at least in part on the location information associated with the activation request.

Third set of user identifiers obtaining unit 1103 is configured to determine a third set of user identifiers associated with other logged in users based at least in part on the requestor identifier of the activation request. In some embodiments, third set of user identifiers obtaining unit 1103 is configured to query a distributed cache and/or a relational database using the requestor identifier for the third set of user identifiers.

Candidate transaction target identifiers extracting unit 1104 is configured to determine a set of candidate transaction target identifiers by extracting user identifiers that are common to/present in each of the second set of user identifiers and the third set of user identifiers.

Candidate transaction target identifiers returning unit 1105 is configured to send the set of candidate transaction target identifiers back to the client device. In some embodiments, candidate transaction target identifiers returning unit 1105 is also configured to receive at least one selected transaction target identifier from the client device and process the activation request based at least in part on the selected transaction target identifier.

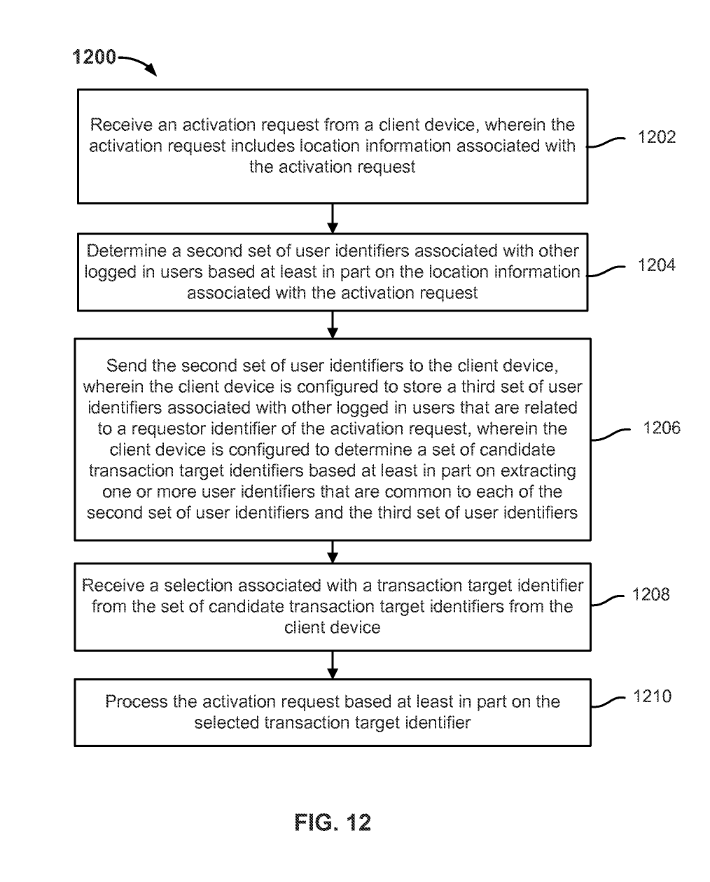

FIG. 12 is a flow diagram showing an embodiment of a process for determining a transaction target identifier. In some embodiments, process 1200 is implemented at system 100 of FIG. 1. In some embodiments, process 200 of FIG. 2 is implemented using process 1200.

At 1202, an activation request is received from a client device, wherein the activation request includes location information associated with the activation request. In some embodiments, the requestor identifier and the time information associated with the activation request are optionally included in the activation request.

At 1204, a second set of user identifiers associated with other logged in users is determined based at least in part on the location information associated with the activation request.

At 1206, the second set of user identifiers is sent to the client device, wherein the client device is configured to store a third set of user identifiers associated with other logged in users that are related to a requestor identifier of the activation request, wherein the client device is configured to determine a set of candidate transaction target identifiers based at least in part on extracting one or more user identifiers that are common to each of the second set of user identifiers and the third set of user identifiers.

In the example of process 1200, the client device itself either stores and/or has access to the third set of user identifiers that includes user identifiers who have had historical relationships with the requestor identifier. As such, the client device may determine on its own which user identifiers of the second set of user identifiers (that comprise user identifiers that have logged in (and/or sent requests) to the service platform close to the location information associated with the activation request of step 1202) are also user identifiers who have had a relationship with the requestor identifier. Therefore, the client device can determine on its own which user identifiers have logged in (and/or sent requests) to the service platform close in location to the activation request of step 1202 and are also related to the requestor identifier and should therefore be included in the set of candidate transaction target identifiers. The set of candidate transaction target identifiers can be presented at the client device.

At 1208, a selection associated with a transaction target identifier from the set of candidate transaction target identifiers is received from the client device.

At 1210, the activation request is processed based at least in part on the selected transaction target identifier.

Process 1200 describes a process in which the client device stores and/or otherwise has access to the third set of user identifiers. By considering user identifiers (that comprise user identifiers that have logged in (and/or sent requests) to the service platform close to the location of the activation request of step 1202) who are also user identifiers who have had a relationship with the requestor identifier, even if there is a certain amount of error with respect to location included in the activation request, the factor of relatedness to the requestor identifier can be used to limit the user identifiers that may be included in the set of candidate transaction target identifiers.

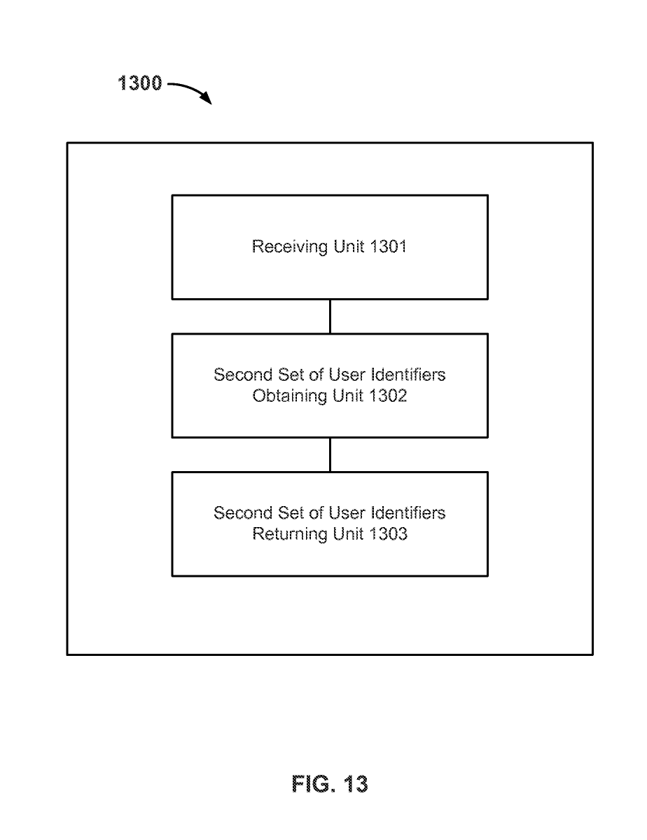

FIG. 13 is a diagram showing an example of a system for determining a transaction target identifier. In some embodiments, system 1300 comprises a server associated with a service platform. In some embodiments, process 1200 of FIG. 12 is implemented at system 1300 of FIG. 13. In the example, system 1300 includes receiving unit 1301, second set of user identifiers obtaining unit 1302, and second set of user identifiers returning unit 1303.

The units can be implemented as software components executing on one or more processors, as hardware such as programmable logic devices, and/or Application Specific Integrated Circuits designed to elements can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices.

Receiving unit 1301 is configured to receive an activation request issued from a client device. In some embodiments, the activation request includes location information associated with the activation request. The activation request optionally includes the requestor identifier and time information associated with the activation request.

Second set of user identifiers obtaining unit 1302 is configured to determine a second set of user identifiers associated with other logged in users based at least in part on the location information associated with the activation request.

Second set of user identifiers returning unit 1303 is configured to send the second set of user identifiers back to the client device. In some embodiments, second set of user identifiers returning unit 1303 is also configured to receive at least one selected transaction target identifier from the client device and process the activation request based at least in part on the selected transaction target identifier.

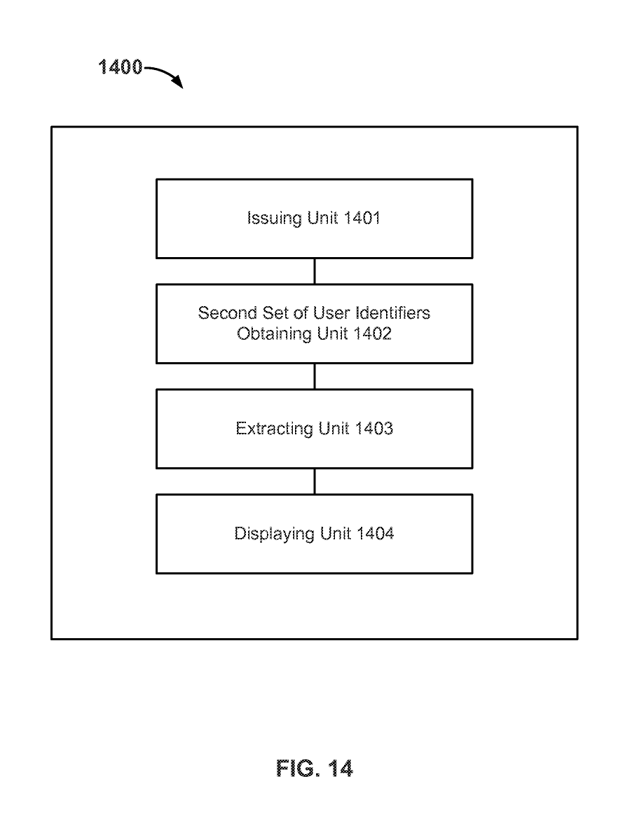

FIG. 14 is a diagram showing an example of a system for determining a transaction target identifier. In some embodiments, system 1400 comprises a client device. In the example, system 1400 includes issuing unit 1401, second set of user identifiers obtaining unit 1402, extracting unit 1403, and displaying unit 1404.

The units can be implemented as software components executing on one or more processors, as hardware such as programmable logic devices, and/or Application Specific Integrated Circuits designed to elements can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices.

Issuing unit 1401 is configured to send an activation request issued to a service platform server (e.g., system 1300 of FIG. 13). In some embodiments, the activation request includes location information associated with the activation request. The activation request optionally includes the requestor identifier and/or the time information associated with the activation request.

Second set of user identifiers obtaining unit 1402 is configured to receive a second set of user identifiers from the service platform server. The second set of user identifiers includes user identifiers associated with other logged in users that were determined based at least in part on the location information associated with the activation request.

Extracting unit 1403 is configured to determine a set of candidate transaction target identifiers based at least in part on extracting one or more user identifiers that are common to each of the second set of user identifiers and a third set of user identifiers. The third set of user identifiers is stored at the client device and includes user identifiers that are related to the requestor identifier associated with the activation request.

Displaying unit 1404 is configured to display the set of candidate transaction target identifiers at a user interface. In some embodiments, displaying unit 1404 is also configured to receive at least one selection of a transaction target identifier via the user interface and send the selection to the service platform server.

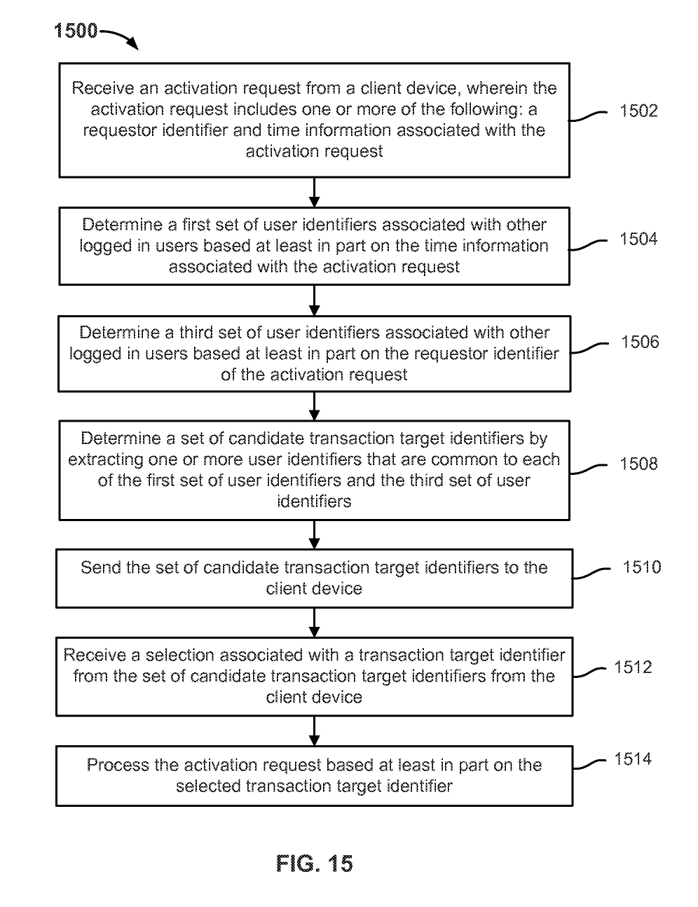

FIG. 15 is a flow diagram showing an embodiment of a process for determining a transaction target identifier. In some embodiments, process 1500 is implemented at system 100 of FIG. 1. In some embodiments, process 200 of FIG. 2 is implemented using process 1500.

At 1502, an activation request is received from a client device, wherein the activation request includes one or more of the following: a requestor identifier and time information associated with the activation request. In some embodiments, the location information associated with the activation request is optionally included in the activation request.

At 1504, a first set of user identifiers associated with other logged in users is determined based at least in part on the time information associated with the activation request.

At 1506, a third set of user identifiers associated with other logged in users is determined based at least in part on the requestor identifier of the activation request.

At 1508, a set of candidate transaction target identifiers is determined by extracting one or more user identifiers that are common to each of the first set of user identifiers and the third set of user identifiers.

At 1510, the set of candidate transaction target identifiers is sent to the client device.

At 1512, a selection associated with a transaction target identifier from the set of candidate transaction target identifiers is received from the client device.

At 1514, the activation request is processed based at least in part on the selected transaction target identifier.

In the example of process 1500, the location information associated with the activation request is not considered in determining the set of candidate transaction target identifiers. Put another way, the location information associated with the activation request is not a constraint/criterion used in determining the set of candidate transaction target identifiers in process 1500. By removing the constraint/criterion of finding candidate transaction target identifiers that are associated with a similar location to the location information associated with the activation request, the correct party to the requested transaction who may be associated with a location that is beyond a preset range of the location information associated with the activation request is not precluded from being determined as part of the set of candidate transaction target identifiers. For example, a requestor identifier activates a payment process at a certain time and in a certain location area, and if the other party to the payment activated a payment process within roughly the same time interval but in a different location, using process 1500, this other party may still be identified as a candidate transaction target identifier even though the other party is not indicated as being within the same location as the requestor identifier. Process 1500 provides greater location-related flexibility in identifying the set of candidate transaction target identifiers.

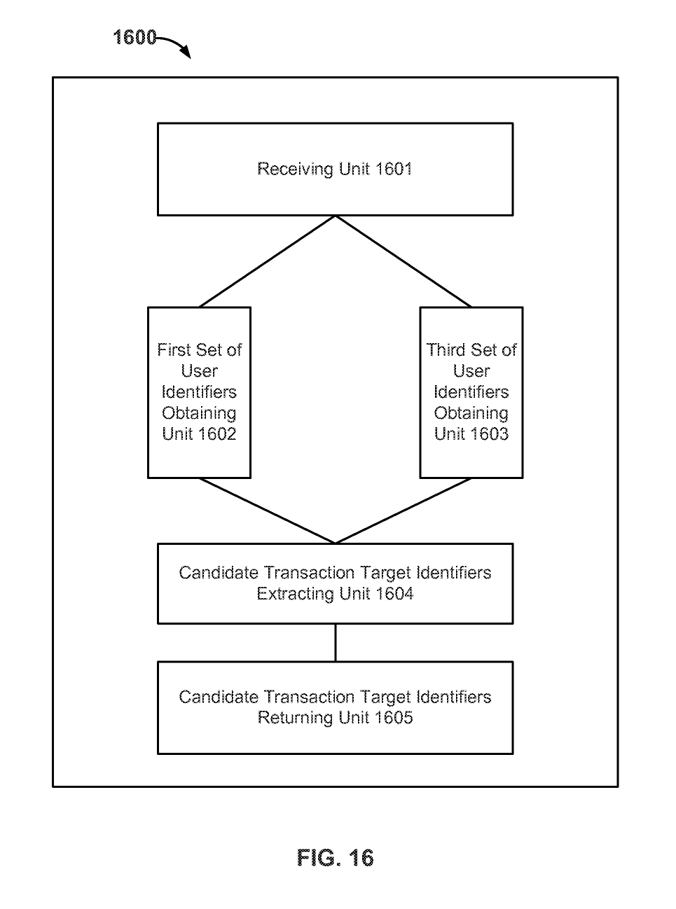

FIG. 16 is a diagram showing an example of a system for determining a transaction target identifier. In some embodiments, process 1500 of FIG. 15 is implemented at system 1600 of FIG. 16. In the example, system 1600 includes receiving unit 1601, first set of user identifiers obtaining unit 1602, third set of user identifiers obtaining unit 1603, extracting unit 1604, and candidate transaction target identifiers returning unit 1605.

The units can be implemented as software components executing on one or more processors, as hardware such as programmable logic devices, and/or Application Specific Integrated Circuits designed to elements can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices.

Receiving unit 1601 is configured to receive an activation request issued from a client device. In some embodiments, the activation request includes one or more of the following: a requestor identifier and time information associated with the activation request. In some embodiments, location information associated with the activation request can be optionally included in the request.

First set of user identifiers obtaining unit 1602 is configured to determine a first set of user identifiers associated with other logged in users based at least in part on the time information associated with the activation request.

Third set of user identifiers obtaining unit 1603 is configured to determine a third set of user identifiers associated with other logged in users based at least in part on the requestor identifier of the activation request. In some embodiments, third set of user identifiers obtaining unit 1603 is configured to query a distributed cache and/or a relational database using the requestor identifier for the third set of user identifiers.

Candidate transaction target identifiers extracting unit 1604 is configured to determine a set of candidate transaction target identifiers by extracting user identifiers that are common to/simultaneously present in each of the second set of user identifiers and the third set of user identifiers.

Candidate transaction target identifiers returning unit 1605 is configured to send the set of candidate transaction target identifiers to the client device. In some embodiments, candidate transaction target identifiers returning unit 1605 is also configured to receive at least one selected transaction target identifier from the client device and process the activation request based at least in part on the selected transaction target identifier.

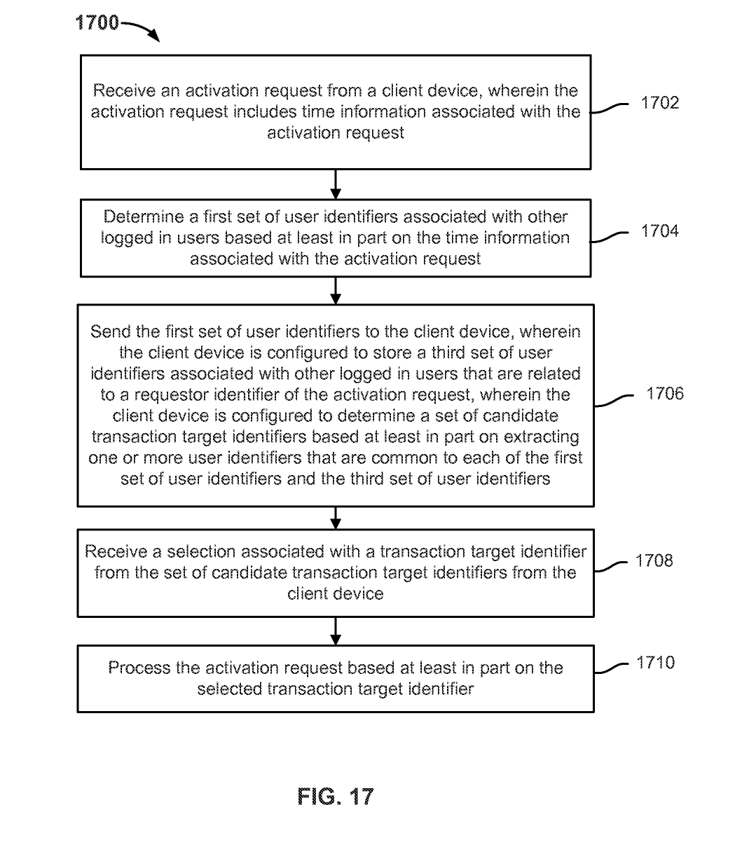

FIG. 17 is a flow diagram showing an embodiment of a process for determining a transaction target identifier. In some embodiments, process 1700 is implemented at system 100 of FIG. 1. In some embodiments, process 200 of FIG. 2 is implemented using process 1700.

At 1702, an activation request is received from a client device, wherein the activation request includes time information associated with the activation request. In some embodiments, the requestor identifier and the location information associated with the activation request are optionally included in the activation request.

At 1704, a first set of user identifiers associated with other logged in users is determined based at least in part on the time information associated with the activation request.

At 1706, the first set of user identifiers is sent to the client device, wherein the client device is configured to store a third set of user identifiers associated with other logged in users that are related to a requestor identifier of the activation request, wherein the client device is configured to determine a set of candidate transaction target identifiers based at least in part on extracting one or more user identifiers that are common to each of the first set of user identifiers and the third set of user identifiers.

In the example of process 1700, the client device itself either stores and/or has access to the third set of user identifiers that includes user identifiers who have had historical relationships with the requestor identifier. As such, the client device may determine on its own which user identifiers of the first set of user identifiers (that comprise user identifiers that have logged in (and/or sent requests) to the service platform close in time to the time information associated with the activation request of step 1702) are also user identifiers who have had a relationship with the requestor identifier. Therefore, the client device can determine on its own which user identifiers have logged in (and/or sent requests) to the service platform close in time to the time information associated with the activation request of step 1702 and are also related to the requestor identifier and should therefore be included in the set of candidate transaction target identifiers. Even if there were errors included in the time information associated with the activation request, the set of candidate transaction target identifiers is still limited to only those user identifiers who are related to the requestor identifier. The set of candidate transaction target identifiers can be presented at the client device.

At 1708, a selection associated with a transaction target identifier from the set of candidate transaction target identifiers is received from the client device.

At 1710, the activation request is processed based at least in part on the selected transaction target identifier.

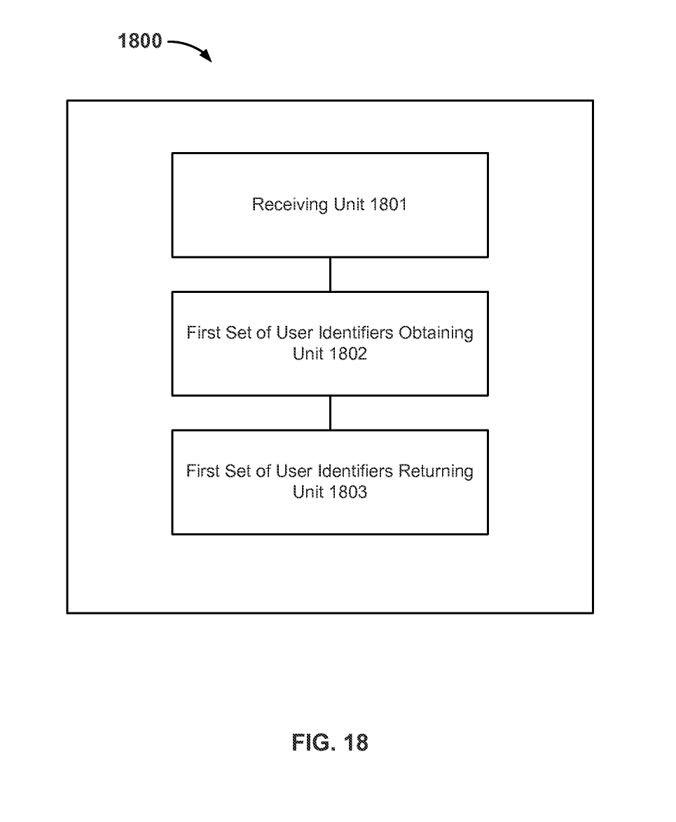

FIG. 18 is a diagram showing an example of a system for determining a transaction target identifier. In some embodiments, system 1800 comprises a server associated with a service platform. In some embodiments, process 1700 of FIG. 17 is implemented at system 1800 of FIG. 18. In the example, system 1800 includes receiving unit 1801, first set of user identifiers obtaining unit 1802, and first set of user identifiers returning unit 1803.

The units can be implemented as software components executing on one or more processors, as hardware such as programmable logic devices, and/or Application Specific Integrated Circuits designed to elements can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices.

Receiving unit 1801 is configured to receive an activation request issued from a client device. In some embodiments, the activation request includes time information associated with the activation request. The activation request optionally includes the requestor identifier and location information associated with the activation request.

First set of user identifiers obtaining unit 1802 is configured to determine a first set of user identifiers associated with other logged in users based at least in part on the location information associated with the activation request.

First set of user identifiers returning unit 1803 is configured to send the first set of user identifiers back to the client device. In some embodiments, first set of user identifiers returning unit 1803 is also configured to receive at least one selected transaction target identifier from the client device and process the activation request based at least in part on the selected transaction target identifier.

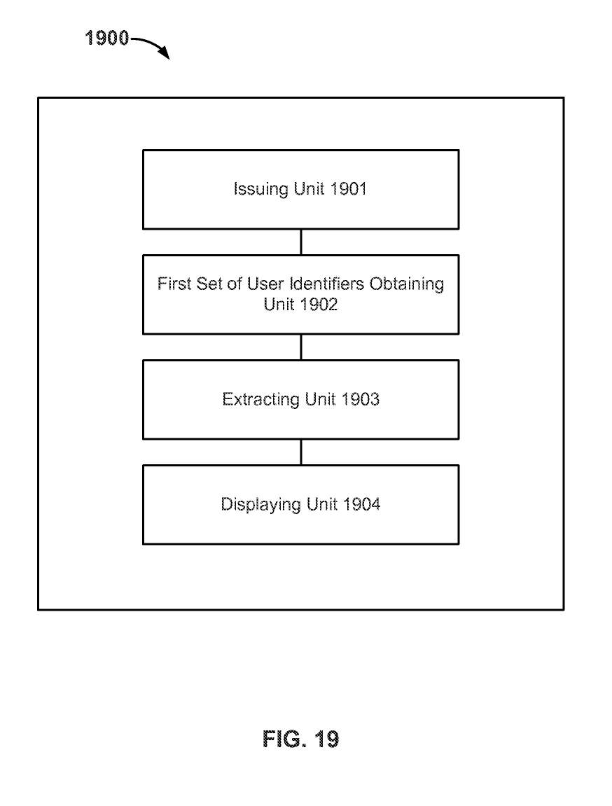

FIG. 19 is a diagram showing an example of a system for determining a transaction target identifier. In some embodiments, system 1900 comprises a client device. In the example, system 1900 includes issuing unit 1901, first set of user identifiers obtaining unit 1902, extracting unit 1903, and displaying unit 1904.

The units can be implemented as software components executing on one or more processors, as hardware such as programmable logic devices, and/or Application Specific Integrated Circuits designed to elements can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices.

Issuing unit 1901 is configured to send an activation request issued to a service platform server (e.g., system 1800 of FIG. 18). In some embodiments, the activation request includes time information associated with the activation request. The activation request optionally includes the requestor identifier and/or the location information associated with the activation request.

First set of user identifiers obtaining unit 1902 is configured to receive a first set of user identifiers from the service platform server. The first set of user identifiers includes user identifiers associated with other logged in users that were determined based at least in part on the time information associated with the activation request.

Extracting unit 1903 is configured to determine a set of candidate transaction target identifiers based at least in part on extracting one or more user identifiers that are common to each of the first set of user identifiers and a third set of user identifiers. The third set of user identifiers is stored at the client device and includes user identifiers that are related to the requestor identifier associated with the activation request.

Displaying unit 1904 is configured to display the set of candidate transaction target identifiers at a user interface. In some embodiments, displaying unit 1904 is also configured to receive at least one selection of a transaction target identifier via the user interface and send the selection to the service platform server.

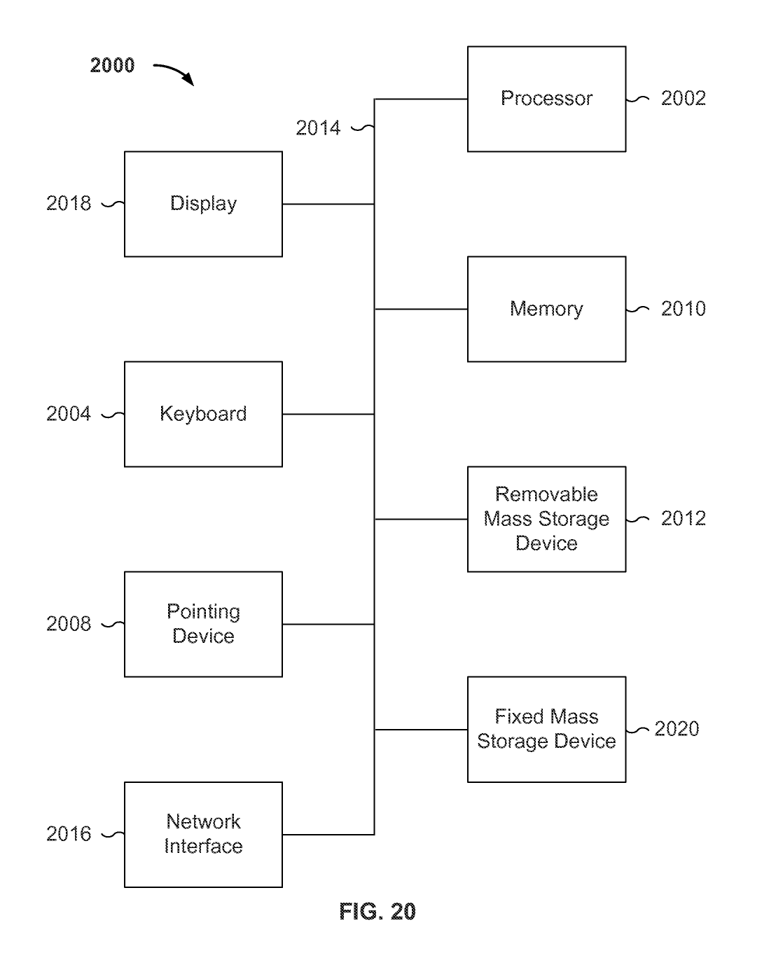

FIG. 20 is a functional diagram illustrating an embodiment of a programmed computer system for implementing determining a transaction target identifier. As will be apparent, other computer system architectures and configurations can be used to determine a transaction target identifier. Computer system 2000, which includes various subsystems as described below, includes at least one microprocessor subsystem (also referred to as a processor or a central processing unit (CPU)) 2002. For example, processor 2002 can be implemented by a single-chip processor or by multiple processors. In some embodiments, processor 2002 is a general purpose digital processor that controls the operation of the computer system 2000. Using instructions retrieved from memory 2010, the processor 2002 controls the reception and manipulation of input data, and the output and display of data on output devices (e.g., display 2018). In some embodiments, processor 2002 includes and/or is used to provide the determination of a transaction target identifier.

Processor 2002 is coupled bi-directionally with memory 2010, which can include a first primary storage area, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 2002. Also as is well known in the art, primary storage typically includes basic operating instructions, program code, data, and objects used by the processor 2002 to perform its functions (e.g., programmed instructions). For example, memory 2010 can include any suitable computer readable storage media, described below, depending on whether, for example, data access needs to be bi-directional or uni-directional. For example, processor 2002 can also directly and very rapidly retrieve and store frequently needed data in a cache memory (not shown).

A removable mass storage device 2012 provides additional data storage capacity for the computer system 2000 and is coupled either bi-directionally (read/write) or uni-directionally (read only) to processor 2002. For example, storage 2012 can also include computer readable media such as magnetic tape, flash memory, PC-CARDS, portable mass storage devices, holographic storage devices, and other storage devices. A fixed mass storage 2020 can also, for example, provide additional data storage capacity. The most common example of fixed mass storage 2020 is a hard disk drive. Mass storage 2012, 2020 generally store additional programming instructions, data, and the like that typically are not in active use by the processor 2002. It will be appreciated that the information retained within mass storages 2012 and 2020 can be incorporated, if needed, in standard fashion as part of memory 2010 (e.g., RAM) as virtual memory.

In addition to providing processor 2002 access to storage subsystems, bus 2014 can also be used to provide access to other subsystems and devices. As shown, these can include a display 2018, a network interface 2016, a keyboard 2004, and a pointing device 2008, as well as an auxiliary input/output device interface, a sound card, speakers, and other subsystems as needed. For example, the pointing device 2008 can be a mouse, stylus, track ball, or tablet, and is useful for interacting with a graphical user interface.

The network interface 2016 allows processor 2002 to be coupled to another computer, computer network, or telecommunications network using a network connection as shown. For example, through the network interface 2016, the processor 2002 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 2002 can be used to connect the computer system 2000 to an external network and transfer data according to standard protocols. For example, various process embodiments disclosed herein can be executed on processor 2002, or can be performed across a network such as the Internet, intranet networks, or local area networks, in conjunction with a remote processor that shares a portion of the processing. Additional mass storage devices (not shown) can also be connected to processor 2002 through network interface 2016.

An auxiliary I/O device interface (not shown) can be used in conjunction with computer system 2000. The auxiliary I/O device interface can include general and customized interfaces that allow the processor 2002 to send and, more typically, receive data from other devices such as microphones, touch-sensitive displays, transducer card readers, tape readers, voice or handwriting recognizers, biometrics readers, cameras, portable mass storage devices, and other computers.

For convenience of description, when describing the device above, functions are described as separate units. Of course, during implementation of the present application, the functions of the various units may be achieved in the same or multiple software and/or hardware configurations.

As can be seen through the description of the embodiment above, persons skilled in the art can clearly understand that the present application can be realized with the aid of software plus the necessary common hardware platform. On the basis of such an understanding, the essence of the technical scheme of the present application, or the part that contributes to the prior art, may be embodied in the form of a software product. The computer software product may be stored in a storage medium, such as ROM/RAM, magnetic disks, or optical disks, and include some commands used to cause a piece of computer equipment (which can be a personal computer, a server, or network equipment) to execute the methods described by the various embodiments of the present application or by certain portions of the embodiments.

All of the embodiments in the Description are described in progressive fashion. Where portions of an embodiment are the same or similar to those of another embodiment, it is sufficient to view the other. Each embodiment puts an emphasis on explaining those areas that are different from other embodiments. In particular, with regard to the system embodiments, since they are basically similar to the method embodiments, relevant explanations may be found in sections of the method embodiments.

The present application may be used in many general or specialized computer systems or configurations. Examples include: personal computers, servers, handheld devices or portable equipment, tablet type equipment, multiprocessor systems, microprocessor-based systems, set-top boxes, programmable consumer electronic equipment, networked PCs, minicomputers, mainframe computers, distributed computing environments that include any of the systems or equipment above, and so forth.

The present application can be described in the general context of computer executable commands executed by a computer, such as a program module. Generally, program modules include routines, programs, objects, components, data structures, etc. to execute specific tasks or achieve specific abstract data types. The present application can also be carried out in distributed computing environments; in such distributed computing environments, tasks are executed by remote processing equipment connected via communication networks. In distributed computing environments, program modules can be located on storage media at local or remote computers that include storage equipment.

Although the present application has been portrayed through embodiments, persons with ordinary skill in the art know that the present application has many variants and variations that do not depart from the spirit of the present application. It is hoped that the attached claims include these variants and variations without departing from the spirit of the present application.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a receiver to receive an activation request from a client device, wherein the activation request includes one or more of the following: a requestor identifier, time information associated with the activation request, and location information associated with the activation request;
an extractor to determine a set of candidate transaction target identifiers based at least in part on the one or more of the following: the requestor identifier, the time information associated with the activation request, and the location information associated with the activation request; and
candidate transaction target identifiers returner to:
send the set of candidate transaction target identifiers to the client device;
receive a selection associated with a transaction target identifier from the set of candidate transaction target identifiers from the client device; and
process the activation request based at least in part on the selected transaction target identifier.

2. The system of claim 1, wherein the location information comprises a location associated with the client device.

3. The system of claim 1, wherein the location information is determined by a wireless carrier.

4. The system of claim 1, wherein:
a first set of user identifiers is determined based at least in part on the time information associated with the activation request;
a second set of user identifiers is determined based at least in part on the location information associated with the activation request; and
a third set of user identifiers is determined based at least in part on the requestor identifier.

5. The system of claim 4, wherein the first set of user identifiers is determined based at least in part on the time information associated with the activation request includes the time information associated with the activation request being classified into a time interval and the first set of user identifiers being determined to be associated with the time interval.

6. The system of claim 4, wherein the second set of user identifiers is determined based at least in part on the location information associated with the activation request includes the second set of user identifiers being determined to be associated with a predetermined range associated with the location information.

7. The system of claim 4, wherein the third set of user identifiers is determined based at least in part on the requestor identifier includes the third set of user identifiers being determined as user identifiers that are related to the requestor identifier.

8. The system of claim 4, wherein to determine the set of candidate transaction target identifiers includes to extract one or more user identifiers that are common to the first set of user identifiers, the second set of user identifiers, and the third set of user identifiers.

9. The system of claim 4, wherein to determine the set of candidate transaction target identifiers includes to extract one or more user identifiers that are common to the second set of user identifiers and the third set of user identifiers.

10. The system of claim 4, wherein to determine the set of candidate transaction target identifiers includes to extract one or more user identifiers that are common to the first set of user identifiers and the third set of user identifiers.

11. The system of claim 4, wherein the third set of user identifiers determined based at least in part on the requestor identifier is stored at the client device.

12. A method, comprising:
receiving an activation request from a client device, wherein the activation request includes one or more of the following: a requestor identifier, time information associated with the activation request, and location information associated with the activation request;
determining, using one or more processors, a set of candidate transaction target identifiers based at least in part on the one or more of the following: the requestor identifier, the time information associated with the activation request, and the location information associated with the activation request;
sending the set of candidate transaction target identifiers to the client device;
receiving a selection associated with a transaction target identifier from the set of candidate transaction target identifiers from the client device; and
processing the activation request based at least in part on the selected transaction target identifier.

13. The method of claim 12, wherein:
a first set of user identifiers is determined based at least in part on the time information associated with the activation request;
a second set of user identifiers is determined based at least in part on the location information associated with the activation request; and
a third set of user identifiers is determined based at least in part on the requestor identifier.

14. The method of claim 13, wherein the first set of user identifiers is determined based at least in part on the time information associated with the activation request includes the time information associated with the activation request being classified into a time interval and the first set of user identifiers being determined to be associated with the time interval.

15. The method of claim 13, wherein the second set of user identifiers is determined based at least in part on the location information associated with the activation request includes the second set of user identifiers being determined to be associated with a predetermined range associated with the location information.

16. The method of claim 13, wherein the third set of user identifiers is determined based at least in part on the requestor identifier includes the third set of user identifiers being determined as user identifiers that are related to the requestor identifier.

17. The method of claim 13, wherein determining the set of candidate transaction target identifiers includes extracting one or more user identifiers that are common to the first set of user identifiers, the second set of user identifiers, and the third set of user identifiers.

18. The method of claim 13, wherein determining the set of candidate transaction target identifiers includes extracting one or more user identifiers that are common to the second set of user identifiers and the third set of user identifiers.

19. The method of claim 13, wherein determining the set of candidate transaction target identifiers includes extracting one or more user identifiers that are common to the first set of user identifiers and the third set of user identifiers.

20. A computer program product, the computer program product comprising a non-transitory computer readable storage medium and comprising computer instructions for:
receiving an activation request from a client device, wherein the activation request includes one or more of the following: a requestor identifier, time information associated with the activation request, and location information associated with the activation request;
determining a set of candidate transaction target identifiers based at least in part on the one or more of the following: the requestor identifier, the time information associated with the activation request, and the location information associated with the activation request;
sending the set of candidate transaction target identifiers to the client device;
receiving a selection associated with a transaction target identifier from the set of candidate transaction target identifiers from the client device; and
processing the activation request based at least in part on the selected transaction target identifier.
